(19) United States
(12) Patent Application Publication
(10) Pub. No.: US 2020/0363597 A1
(43) Pub. Date: Nov. 19, 2020

(54) OPTICAL TRANSMITTER, OPTICAL TRANSCEIVER, AND METHOD FOR MANUFACTURING THE OPTICAL TRANSMITTER

(71) Applicants: SHUNSIN TECHNOLOGY (ZHONG SHAN) LIMITED, Zhongshan (CN); ShunSin Technology Holdings Limited Taiwan Branch, New Taipei City (TW)

(72) Inventor: GUANG-SHENG HE, Zhongshan City (CN)

(21) Appl. No.: 16/718,276

(22) Filed: Dec. 18, 2019

(30) Foreign Application Priority Data
May 16, 2019 (CN) 201910407732.5

(51) Int. Cl. G02B 6/42

(52) U.S. Cl. CPC G02B 6/4239; G02B 6/4245; G02B 6/4226

(57) ABSTRACT

A method for manufacturing an optical transmitter and an optical receiver, relying on substrate placement and being adhesively fixed in place instead of using a multitude of mirrors is disclosed. The optical transmitter for example includes a substrate, a laser, and a lens module. The laser is laid on a surface of the substrate, the laser emits a light beam in a direction substantially parallel to the surface. The lens module is also disposed on the surface of the substrate and is laid so as to adjust and correct an optical path of the light beam to couple the light beam to an optical fiber.

### FIELD

The subject matter herein generally relates to optical transmitters, optical transceivers and methods of the optical transmitters.

### BACKGROUND

Networks using optical communications have low transmission loss, high data confidentiality, immunity against interference, and large bandwidth. Optical transceivers are basic components for optical communication, which receive optical signals from optical communication networks and convert the optical signals into electrical signals, and the reverse.

However, conventional optical modules use mirrors to adjust light paths, which requires many optical devices, increasing cost. In addition, the light paths of the conventional optical modules are complicated, causing more speckle patterns and increasing risk of data errors as well as reducing the reliable range of the network.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a block diagram of an optical transceiver according to an embodiment of the disclosure;

FIG. 2 is a cross-sectional view of an optical transmitter according to an embodiment of the disclosure;

FIG. 3 is an enlarged view of part A in FIG. 2;

FIG. 4 is a cross-sectional view of an optical receiver according to an embodiment of the disclosure; and

FIG. 5 is a flow chart of a method for manufacturing the optical transmitter according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections.

The connection can be such that the objects are permanently connected or releasably connected. The term “comprising,” when utilized, means “comprising, but not necessarily limited to”; it specifically indicates open-ended inclusion or membership in the so-described combination, group, series, and the like.

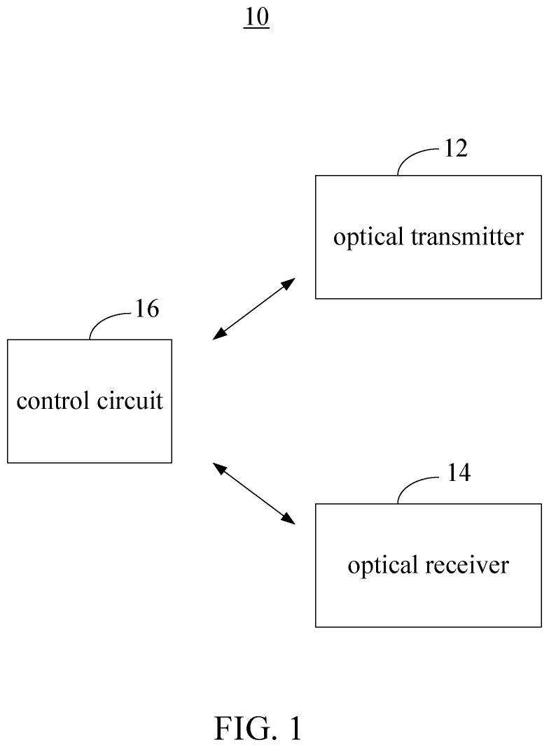

FIG. 1 shows an optical transceiver 10 according to an embodiment of the disclosure. The optical transceiver 10 according to an embodiment of the disclosure comprises an optical transmitter 12, an optical receiver 14, and a control circuit 16. According to an embodiment of the disclosure, there may be multiple sets of optical transmitters 12 and optical receivers 14 for simultaneous optical signal transmission on multiple channels. Thus, the optical transceiver 10 can transmit and receive optical signals in a time division or a wave division manner. The control circuit 16 is configured to process electrical signals from the optical receiver 14 or to the optical transmitter 12. The control circuit 16 can be a digital signal processing integrated circuit. In other embodiments, the control circuit 16 can be integrated into the optical transmitter 12 and the optical receiver 14.

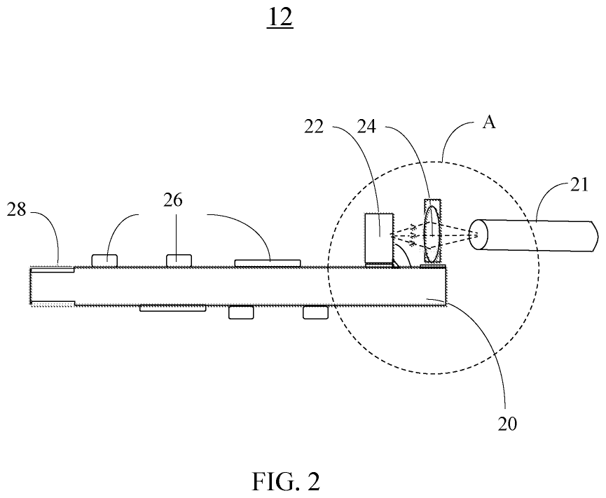

FIG. 2 shows a cross-sectional view of the optical transmitter 12 according to an embodiment of the disclosure. In an embodiment, the optical transmitter 12 comprises a substrate 20, a laser 22, a lens module 24, electronic components 26, and an input and output port 28. According to an embodiment of the disclosure, the substrate 20 can be formed from various materials, including a tantalum, a polymer, a ceramic material, and other materials. The laser 22, the lens module 24, the electronic components 26, and the input and output port 28 are disposed on the substrate 20. In an embodiment of the disclosure, the laser 22 can be a single or a plurality of vertical cavity surface emitting laser diodes (hereinafter referred to as VCSELs). The VCSELs form an array to emit optical signals. In other embodiments, the laser 22 can be a single or a plurality of surface-emitting laser diodes, light emitting diodes, edge emitting laser diodes (EELD), or distributed feedback lasers (DFB).

The electronic components 26 comprise a laser driver for driving the laser 22 and other circuit components necessary to perform an optical signal transmission function. In other embodiments, the electronic components 26 may comprise a part of the control circuit 16. The control signals and the electronic signals input via the input and output port 28 are converted into light beams by the laser driver.

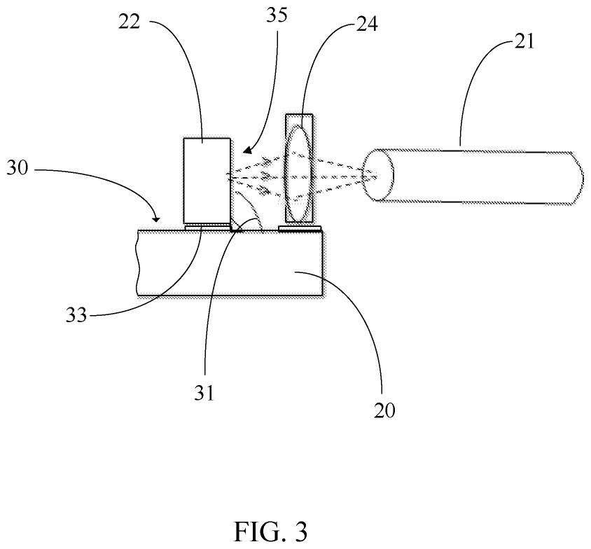

FIG. 3 shows an enlarged view of part A in FIG. 2. Referring to FIG. 3, the laser 22 is electrically connected to the substrate 20 through wires 31, and electrically connected to the laser driver of the electronic components 26 through interconnects of the substrate 20. According to an embodiment of the disclosure, the wires 31 can be electrically connected to the laser 22 and the substrate 20 by a wire bonding process. The laser 22 is affixed to a surface 30 of the substrate 20 through an adhesive layer 33. According to an embodiment of the disclosure, the adhesive layer 33 can be formed from various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as materials having adhesive properties are applicable to the disclosure.

The laser 22 has a light-emitting surface 35 that emits light beams along the direction substantially parallel to the surface 30 of the substrate 20. As shown in FIG. 3, the laser 22 emits the light beams toward a side facing the lens module 24. Taking the laser 22 as a hexahedron as an example, the laser 22 comprises four laser side surfaces orthogonal to and adjacent to the light-emitting surface 35, and one of the four laser side surfaces is affixed to the surface 30 of the substrate 20 through the adhesive layer 33.

The lens module 24 has a light-incident surface, a light-emitting surface, and a lens side surface between the light-incident surface and the light-emitting surface, and the lens side surface is orthogonal to the light-incident surface. The light beams emitted from the laser 22 are incident to the lens module 24 through the light-incident surface, and output from the light-emitting surface. The lens side surface of the lens module 24 is also affixed to the surface 30 of the substrate 20 through the adhesive layer 33.

According to an embodiment of the disclosure, the lens module 24 is a collecting lens, and the collecting lens concentrates the light beams emitted by the laser 22 and forwards concentrated light beams to an optical fiber 21, the same then being transmitted to other optical receivers through the optical fiber 21. In accordance with other embodiments, the lens module 24 may also be provided with collimating lenses as needed to adjust the directions of the light beams, such as to render the light beams parallel.

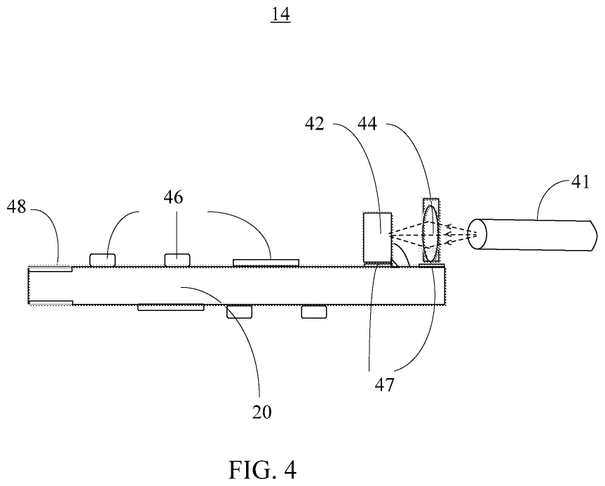

FIG. 4 shows a cross-sectional view of the optical receiver 14 according to an embodiment of the disclosure. The optical receiver 14 comprises a substrate 20, a photodetector 42, a lens module 44, electronic components 46, and an input and output port 48. According to an embodiment of the disclosure, the substrate 20 can be formed from various materials, including a tantalum, a polymer, a ceramic material, and other materials. The photodetector 42, the lens module 44, the electronic components 46, and the input and output port 48 are disposed on the substrate 20. It should be noted that since the optical receiver 14 and the optical transmitter 12 have similar structures, a description of one will not be repeated. In addition, although the optical receiver 14 and the optical transmitter 12 are both disposed on the substrate 20, in other embodiments, they may be respectively disposed on different substrates.

Light beams emitted by other light emitters (not shown) are transmitted through an optical fiber 41, and emitted toward the lens module 44. The lens module 44 has a light-incident surface, a light-emitting surface, and a lens side surface between the light-incident surface and the light-emitting surface. The light beams emitted from the optical fiber 41 are incident to the lens module 44 through the light-incident surface, and output from the light-emitting surface. The lens side surface of the lens module 44 is also adhered to the surface of the substrate 20 through an adhesive layer 47. According to an embodiment of the disclosure, the lens module 44 is a collecting lens, and the light beams emitted by the optical fiber 41 are concentrated by such collecting lens, and then coupled to the photodetector 42. In accordance with other embodiments, the lens module 44 may also be provided with collimating lenses as needed to adjust the directions of the light beams, such as to render the light beams parallel.

The photodetector 42 can be a PIN photodiode or an avalanche photodiode (APD) for converting the light beams coupled by the lens module 44 into electrical signals. The electronic components 46 comprise circuit components necessary for controlling the photodetector 42 and processing the electrical signals generated by the photodetector 42. For example, the electronic components 46 may comprise a transimpedance amplifier to convert the electrical signals generated by the photodetector 42 into electrical signals with smaller amplitude, and also comprise circuits to convert the amplified electrical signals into digital signals. In other embodiments, the electronic components 46 may comprise a part of the control circuit 16.

According to an embodiment of the disclosure, the photodetector 42 is electrically connected to the substrate 20 through wires, and electrically connected to the electronic components 46 through interconnections of the substrate 20. The photodetector 42 is affixed to the surface of the substrate 20 through the adhesive layer 47. According to an embodiment of the disclosure, the adhesive layer 47 can be formed from various materials, including a polyimide (PI), polyethylene terephthalate (PET), Teflon, liquid crystal polymer (LCP), polyethylene (PE), polypropylene (PP), polystyrene (PS), polyvinyl Chloride (PVC), nylon or polyamides, polymethyl polymethylmethacrylate (PMMA), acrylonitrile-butadiene-styrene, phenolic pesins, epoxy resin, polyester, silicone, polyurethane (PU), polyamide-imide (PAI) or a combination thereof, not being limited thereto, as long as materials having adhesive properties are applicable to the disclosure.

The photodetector 42 has a light receiving surface. The received light beams are transmitted along the direction substantially parallel to the surface of the substrate 20. As shown in FIG. 4, the light beams emitted by the optical fiber 41 are emitted toward the left side of FIG. 4 along the direction substantially parallel to the surface of the substrate 20, and then are coupled to the photodetector 42 via the lens module 44. Taking the photodetector 42 as a hexahedron as an example, the photodetector 42 comprises four side surfaces orthogonal to and adjacent to a light-receiving surface, and one of the four side surfaces is affixed to the surface of the substrate 20 through the adhesive layer 47.

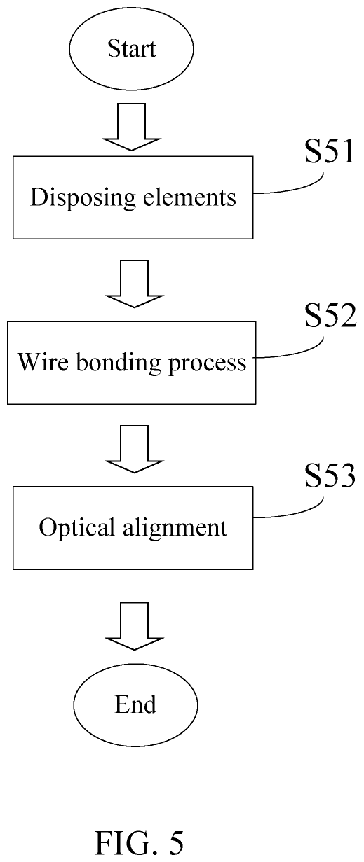

FIG. 5 shows a method for manufacturing the optical transmitter 12 according to an embodiment of the disclosure. Referring to FIG. 2, elements are disposed on the substrate 20 (step S51), the elements comprise the laser 22, the lens module 24, the electronic components 26, and the input and output port 28. According to an embodiment of the disclosure, the substrate 20 can be formed from various materials, including a tantalum, a polymer, a ceramic material, and other materials. In an embodiment of the disclosure, the laser 22 can be a single or a plurality of VCSELs. The VCSELs form an array to emit optical signals. In other embodiments, the laser 22 can be a single or a plurality of surface-emitting laser diodes, light emitting diodes, edge emitting laser diodes (EELD), or distributed feedback lasers (DFB).

The electronic components 26 comprise a laser driver for driving the laser 22 and other circuit components necessary to perform an optical signal transmission function. In other embodiments, the electronic components 26 may comprise a part of the control circuit 16. The control signals and the electronic signals input via the input and output port 28 are converted into light beams by the laser driver. According to an embodiment of the disclosure, one of the laser side surfaces of the laser 22 is affixed to the surface 30 of the substrate 20 through the adhesive layer 33, and the electronic components 26 can be mounted on the substrate 20 using surface mount technology (SMT) or by soldering. In the substrate 20, there are pre-designed interconnecting structures, and the electronic components 26 and the control circuit 16 can be electrically connected through the interconnecting structures.

In step S52, a wire bonding process is performed. The wire bonding process is to electrically connect the laser 22 and the interconnect structures of the substrate 20 through gold wires. In step S53, an optical alignment is performed. First, a positioning element may be disposed on the substrate 20 to assist in preliminary alignment of the laser 22 with the lens module 24. An ultraviolet (UV) glue may be applied between the lens module 24 and the substrate 20. To improve the positioning accuracy, the position can be aligned by assistance of a charge coupled device (CCD) camera. After the lens module 24 is positioned, the UV glue is irradiated with ultraviolet lights to cure the UV glue, and then the lens module 24 is affixed by the adhesive layer 33. Thus, fabrication of the optical transmitter 12 is completed. It should be noted that the method or process does not rely on a particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the disclosure should not be limited to the performance of their steps in the order written, and one skilled in the art can readily appreciate that the sequences may be varied and still remain within the spirit and scope of the disclosure. In addition, regarding the method of manufacture of the optical receiver 14, it is similar to the steps shown in FIG. 5. The only difference is that the laser 22 is replaced with the photodetector 42, thus, detailed manufacturing need not be described. It should be noted that the optical transmitter 12 according to the disclosure does not need to be used in combination with the optical receiver 14 according to the disclosure, and may also be a standalone device connecting to other optical receivers for receiving optical signals.

According to an embodiment of the disclosure, the light beams emitted by the laser 22 are emitted in the direction parallel to the substrate 20, and concentrated by the lens module 24. The light beams can be transmitted to the optical fiber 21 without light reflection steps by mirror components. Under this architecture, in addition to reducing the optical components (omitting the mirror components), the optical transmission path can be simplified, the optical transmission efficiency and the manufacturing yield can be enhanced, and the optical transmission quality can be improved to reduce speckle patterns.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and comprising the full extent established by the broad general meaning of the terms used in the claims. It will therefore be appreciated that the embodiments described above may be modified within the scope of the claims.

What is claimed is:

1. An optical transmitter comprises:
a substrate having a surface;
a laser disposed on the substrate, the laser having a light-emitting surface emitting a light beam in a direction substantially parallel to the surface; and
a lens module disposed on the surface for adjusting an optical path of the light beam to couple the light beam to an optical fiber.

2. The optical transmitter as claimed in claim 1, wherein the laser has a laser side surface orthogonal to the light-emitting surface, and the laser side surface is adhered to the surface of the substrate through an adhesive layer.

3. The optical transmitter as claimed in claim 1, wherein the lens module has a light-incident surface, a light-emitting surface, and a lens side surface between the light-incident surface and the light-emitting surface, and the lens side surface is adhered to the surface of the substrate through an adhesive layer.

4. The optical transmitter as claimed in claim 1, wherein the laser is a vertical cavity surface emitting laser.

5. An optical transceiver comprises:
a substrate having a surface;
an optical transmitter comprising:
a laser disposed on the substrate, the laser having a light-emitting surface emitting a first light beam in a direction substantially parallel to the surface; and
a first lens module disposed on the surface for adjusting a first optical path of the first light beam to couple the first light beam to a first optical fiber; and
an optical receiver comprising:
a second lens module disposed on the surface for coupling a second light beam from a second optical fiber and adjusting a second optical path of the second light beam; and
a photodetector disposed on the substrate, having a light receiving surface receiving the second light beam in a direction substantially parallel to the surface, and converting the second light beam into an electrical signal.

6. The optical transceiver as claimed in claim 5, wherein the laser has a laser side surface orthogonal to the light-emitting surface, and the laser side surface is adhered to the surface of the substrate through an adhesive layer.

7. The optical transceiver as claimed in claim 5, wherein the first lens module has a light-incident surface, a light-emitting surface, and a lens side surface between the light-incident surface and the light-emitting surface, and the lens side surface is adhered to the surface of the substrate through an adhesive layer.

8. The optical transmitter as claimed in claim 5, wherein the laser is a vertical cavity surface emitting laser.

9. A method for manufacturing an optical transmitter, comprising:
providing a substrate having a surface;
disposing a laser on the substrate, the laser having a light-emitting surface emitting a light beam in a direction substantially parallel to the surface; and
disposing a lens module on the surface for adjusting an optical path of the light beam to couple the light beam to an optical fiber
performing an optical alignment of the laser and the lens module; and
disposing a plurality of electronic components and an input and output port on the substrate.

10. The method as claimed in claim 9, wherein the laser has a laser side surface orthogonal to the light-emitting surface, and the laser side surface is adhered to the surface of the substrate through an adhesive layer.

11. The method as claimed in claim 9, wherein the lens module has a light-incident surface, a light-emitting surface, and a lens side surface between the light-incident surface and the light-emitting surface, and the lens side surface is adhered to the surface of the substrate through an adhesive layer.

12. The method as claimed in claim 9, wherein the laser is a vertical cavity surface emitting laser.
